(19) United States
(12) Patent Application Publication
(10) Pub. No.: US 2024/0010948 A1
(43) Pub. Date: Jan. 11, 2024

(54) FABRIC CONDITIONER COMPOSITION

(71) Applicant: Conopco, Inc., d/b/a UNILEVER, Englewood Cliffs, NJ (US)

(72) Inventors: John Francis HUBBARD, Knutstord (GB); Wan HUNG, Liverpool (GB)

(73) Assignee: Conopco, Inc., d/b/a UNILEVER, Englewood Cliffs, NJ (US)

(21) Appl. No.: 18/270,585

(22) PCT Filed: Dec. 22, 2021
(86) PCT No.: PCT/EP2021/087275

§ 371 Date: Jun. 30, 2023

(30) Foreign Application Priority Data
Jan. 11, 2021 (EP) 21150895.7

(51) Int. Cl. C11D 3/00; C11D 11/00; C11D 3/50; C11D 3/30

(52) U.S. Cl. CPC C11D 3/0015; C11D 11/0017; C11D 3/505; C11D 3/30

(57) ABSTRACT

A fabric conditioner composition comprising; a) Ester linked quaternary ammonium compounds; and b) 0.1 to 30 wt. % perfume materials; wherein the ester linked quaternary 5 ammonium compounds comprise carbon chains derived from fatty acids; the fatty acids have an iodine value of 0 to 75; and the fatty acids comprise non-edible rice bran fatty acids.

### Field of the Invention

The present invention is in the field of fabric conditioners, in particular fabric conditioners having improved viscosity.

### BACKGROUND OF THE INVENTION

The viscosity of a fabric conditioner is an important feature for consumers. If the viscosity of a product is too high, there is a risk that it will not be fully dispensed during the rinse cycle. Additionally, a build-up of fabric conditioner can lead to blockages in the washing machine.

Changing the viscosity of a product often involves adding or removing ingredients. This is not desirable since this either leads to an increase in cost (when adding ingredients) or a reduction in benefits delivered to the fabric (when ingredients are removed). There is an ongoing need to be able to reduce the viscosity of a fabric conditioner while maintaining the levels of ingredients in the composition and therefore delivering the same benefits per dose of the composition.

### SUMMARY OF THE INVENTION

In a first aspect of the present invention is provided a fabric conditioner composition comprising;
a. Ester linked quaternary ammonium compounds; and
b. 0.1 to 30 wt. % perfume materials;
   wherein the ester linked quaternary ammonium compounds comprise carbon chains derived from fatty acids; the fatty acids have an iodine value of 0 to 75; and the fatty acids comprise non-edible rice bran fatty acids.

In a second aspect of the present invention is provided a method of reducing the viscosity of a fabric conditioner composition wherein ester linked quaternary ammonium compounds comprising carbon chains derived from fatty acids; the fatty acids having an iodine value of 0 to 75; and the fatty acids comprising non-edible rice bran fatty acids; are included in the fabric conditioner composition as the fabric softening active.

### DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Fabric softening active

The compositions described herein comprise esterquats (ester linked quaternary ammonium compounds) which comprise carbon chains derived from fatty acids, the fatty acids have an iodine value of 0 to 75; and the fatty acids comprise non-edible rice bran fatty acids produced as a by-product in rice bran processing.

Esterquats are a class of cationic surfactants mainly used in laundry applications such as fabric softeners. Esterquats generally contain a long chain fatty acid group linked to a quaternary ammonium group via an ester linkage. In the fabric softening active used in the present invention, the esterquats comprise the long chain fatty acid groups sourced from non-edible rice bran fatty acids produced as a by-product in rice bran processing and extraction of rice bran oil.

Rice bran oil is a by-product of rice bran processing; however, the oil is categorized as an edible product. Thus, food-grade oil is often wasted for non-food purposes, when it is hydrolysed and used for the synthesis of esterquats. Therefore, the use of rice bran oil for the manufacture of esterquats is undesirable. However there are other sources of fatty acids from rice bran, other than from rice bran oil (via hydrolysis), which do not fall under the edible category. During extraction of rice bran oil, a substantial amount of oil undergoes degradation due to enzymatic activity, forming fatty acids in the crude rice bran oil. This crude rice bran oil is non-edible. To make the crude rice bran oil edible, the fatty acid by-product must be removed. The crude rice bran oil is refined by separating the fatty acids by alkali refining or steam distillation. The resultant rice bran fatty acids generated as the by-product of rice bran oil extraction are non-edible and hence are more favourable for the production of products unrelated to food. As used herein, ‘non-edible rice bran fatty acids’ are fatty acids produced as a by-product during the extraction and purification of rice bran oil.

Unless stated otherwise, the abbreviation RBFA and the term “rice bran fatty acids” refer herein to rice bran fatty acids which stem from a non-edible source, i.e. fatty acids which result from the enzymatic degradation of rice bran oil during processing and are separated from crude rice bran oil.

The basic chemistry involved in the synthesis of esterquats using RBFA corresponds with the prior art involving palm oil fatty acids.

The ester-linked quaternary ammonium compound described herein comprise carbon chains sourced from rice bran fatty acids. The carbon chain length distribution, i.e. the proportion of different length fatty acid chains is dictated by the natural distribution of carbon chains in rice bran. Natural variation will occur, however preferably the chain length distribution in the esterquats is of 20 to 35% C16 fatty acid chains, 60 to 75% C18 fatty acid chains, more preferably 22 to 32% C16 and 62 to 72% C18, by weight of total fatty acid chains. These numbers include both saturated and unsaturated C16 or C18 chains. This chain length distribution of rice bran fatty acids contributes to the lower viscosity in the fabric conditioner.

The ester-linked quaternary ammonium compounds described herein comprise rice bran fatty acids. However, they may comprise fatty acid carbon chains from other sources, for example tallow, palm oil, sunflower oil etc. Preferably the esterquat comprises at least 50% rice bran fatty acids weight of total fatty acid chains, more preferably, 75% and most preferably 95% by weight of total fatty acid chains.

Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55%, or even no more that 45% of the fabric softening compound and at least 10 wt. % of the monoester linked component.

A first group of ester-linked quaternary ammonium compounds suitable for use in the present invention is represented by formula (I):

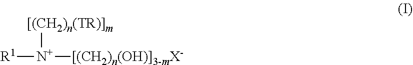

wherein each R is independently selected from a C5 to C35 alkyl or alkenyl group, preferably at least one R is a carbon chain derived from rice bran fatty acids, more preferably all R groups are a carbon chain derived from rice bran fatty acids; R1 represents a Cl to C4 alkyl, C2 to C4 alkenyl or a Cl to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X- is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

A second group of ester-linked quaternary ammonium compounds suitable for use in the invention is represented by formula (II):

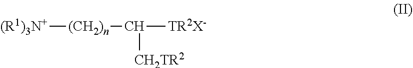

wherein each R1 group is independently selected from Cl to C4 alkyl, hydroxyalkyl or C2 to C4 alkenyl groups; and wherein each R2 is independently selected from a C5 to C35 alkyl or alkenyl group, preferably at least one R2 is a carbon chain derived from rice bran fatty acids, more preferably all R2 groups are a carbon chain derived from rice bran fatty acids; and wherein n, T, and X- are as defined above.

Preferably, these materials also comprise an amount of the corresponding mono-ester.

A third group of ester-linked quaternary ammonium compounds suitable for use in the invention is represented by formula (III):

(R¹)₂—N*—[(CH₂)ₙ—T—R²]₂ X⁻ (III)

wherein each R1 group is independently selected from C1 to C4 alkyl, or C2 to C4 alkenyl groups; and wherein each R2 is independently selected from a C5 to C35 alkyl or alkenyl group, preferably at least one R2 is a carbon chain derived from rice bran fatty acids, more preferably all R2 groups are a carbon chain derived from rice bran fatty acids; and n, T, and X- are as defined above.

A particular example of the fourth group of ester-linked quaternary ammonium compounds is represented the by the formula:

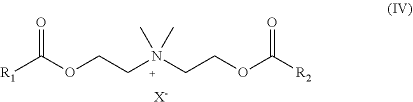

A fifth group of ester-linked quaternary ammonium compounds suitable for use in the invention are represented by formula:

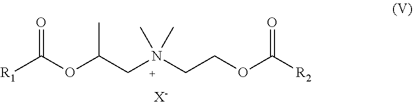

R1 and R2 are each independently selected from a C5 to C35 alkyl or alkenyl group, preferably at least one R1 or R2 is a carbon chain derived from rice bran fatty acids, more preferably both R1 and R2 groups are a carbon chain derived from rice bran fatty acids. X- is as defined above.

The iodine value of the fatty acids used in the production of the ester-linked quaternary ammonium compound is from 0 to 75, this means that partial hydrogenation may have occurred. Generally, hydrogenation will be catalytic hydrogenation. More preferably the iodine value is from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of ester-linked quaternary ammonium compound materials present in the composition, the iodine value, referred to above, represents the mean iodine value of the parent fatty acyl compounds or fatty acids of all the quaternary ammonium materials present. Likewise, if there are any saturated ester-linked quaternary ammonium compound materials present in the composition, the iodine value represents the mean iodine value of the parent acyl compounds of fatty acids of all the quaternary ammonium materials present.

The measurement of the degree of unsaturation present in a material may be measured by a method of nmr spectroscopy as described in Anal. Chem., 34, 1136 (1962) Johnson and

Shoolery.

A specific synthesis process for the preparation of esterquats from RBFA is described in WO 2020/011876.

In particular, esterquats for use in the present invention may preferably be produced following the steps of:
(i) esterification of a fatty acid or a mixture of fatty acids with an alkanolamine to form an ester amine or a mixture of ester amines; and
(ii) quaternisation of the amino group of the resultant ester amine or the amino groups of the mixture of ester amines with a quaternising agent, preferably dimethyl sulphate, wherein the fatty acid or mixture of fatty acids is based on a rice bran fatty acid or a mixture of rice bran fatty acids from non-edible sources generated during refinement of rice bran oil.

In the process, the esterification step (i) is typically carried out at temperatures between 50 and 250° C., preferably between 100 and 200° C., more preferably between 130 and 180° C. If the temperature is too low, the reaction is significantly slowed down and thus is not applicable on an industrial scale. However, if the temperature is too high, decomposition products occur at a high rate, thus limiting the usefulness of the product mixture.

Preferably, the esterification step (i) is carried out under conditions in which generated water is continuously removed from the reaction vessel. For example, water removal may be accomplished by adding molecular sieves to the reaction mixture, by attaching a Dean-Stark-apparatus or distillation apparatus to the reaction vessel, or by applying vacuum to the reaction vessel. Preferably, the reaction is carried out under vacuum or with a distillation apparatus attached.

The alkanolamine used in the process according to the invention may be any alkanolamine, however tertiary alkanolamines are preferred. Even more preferred are trialkanolamines, especially triethanolamine.

The rice bran oil, from the refinement from which the non-edible source of rice bran fatty acids is generated, is not particularly limited. It is, however, desirable to select rice bran oil that is a side product of rice bran processing. The rice bran itself is also not limited to specific rice bran, but is preferably rice bran that is a by-product of rice processing.

The rice bran fatty acids from non-edible sources are usually obtained as a mixture of several fatty acids and often contain impurities that prevent the formation of high quality esterquat composition products using conventional processes. Therefore, the rice bran fatty acids may preferably be separated and/or chemically processed before they are subjected to the esterification step (i). Chemical processing may include any chemical processing steps typically used for processing fatty acids, however chemical processes for saturating unsaturated bonds are preferred. Exemplary means of chemical processing of RBFA are halogenation, hydrohalogenation, hydroboration, ozonolysis, Diels-Alder reactions, hydrogenation, and epoxidation. Preferred means of chemical processing of the rice bran fatty acids from the non-edible source are epoxidation and catalytic hydrogenation.

Separation techniques for rice bran fatty acids may include any known separation techniques that are applicable for the separation of fatty acids from each other and/or from further impurities. These separation techniques include, but are not limited to crystallisation, winterisation, distillation, sublimation, filtration, chromatography including column, flash, and high performance liquid chromatography, liquid-liquid extraction and solid-liquid-extraction. Preferable separation techniques are crystallisation, winterisation and/or distillation.

The molar ratio of rice bran fatty acids to alkanolamine in the esterification step (i) is typically from 1:2 to 3:1, preferably 1:1 to 3:1, more preferably from 1:1 to 2:1. If the ratio is too low, the resultant ester amines are formed in an undesirably low concentration. However, if it is too high, the resultant product exceeds the desired acidity. Accordingly, depending on the ratio and the employed alkanolamine, the resultant ester amine or mixture of ester amines may contain monoesters, diesters, triesters or mixtures thereof.

The quaternisation step (ii) is typically carried out at temperatures from 0 to 180° C., preferably from 20 to 120° C., more preferably from 50 to 100° C. If the temperature is too low, the reaction is significantly slowed down and thus is not applicable on an industrial scale. However, if the temperature is too high, decomposition products occur at a higher rate and undesired methylation of the other functional groups may take place.

The quaternising agent in the quaternization step (ii) is not particularly limited and may be selected, e.g. from trialkyl oxonium salts, alkyl halides, dialkyl phosphates, dialkyl carbonates, alkyl sulphonates and dialkyl sulphates, however dialkyl sulphates are preferred, especially dimethyl sulphate.

In the quaternization step (ii) the molar ratio between the ester amine and the quaternising agent is typically from 2:1 to 1:3, preferably from 1.5:1 to 1:2, most preferably from 1.1:1 to 1:1.1. If the ratio is too low, the quaternisation of the ester amine or the mixture of ester amines is not complete after the reaction is finished. If the ratio is too high, there is a risk that other functional groups of the product are alkylated.

Preferably, at least a part of the quaternisation step (ii), more preferably the full quaternization step (ii) is carried out in the absence of a solvent, because solvents may be alkylated by the quaternizing agent, which may result in increased odour of the final product. However, one or more solvents may be added to the resultant mixture after the quaternization is at least partially completed, preferably fully completed. The solvent is not particularly limited, and can be selected from, e.g. lower alcohols having from 1 to 6 carbon atoms such as ethyl alcohol, propyl alcohol, isopropyl alcohol, etc; polyols, such as ethylene glycol, diethylene glycol, propylene glycol, polyethylene glycol and glycerin, and they can be used alone or in a combination thereof. Preferably the solvent added after the at least partial completion of the quaternization step is an alcohol. Most preferably, the alcohol is ethanol or isopropanol.

The solvent may comprise further solvent components, such as aromatic hydrocarbons, aliphatic hydrocarbons, ethers, esters, lactones, lactams, amides, amines, furans and others. Preferably the solvent does not contain any of these further solvent components.

An example lab scale preparation of a suitable esterquat is as follows: 100 g (0.35 moles) of rice bran fatty acid obtained as a by-product from rice bran oil processing, may be reacted with triethanolamine (34.8 g, 0.234 moles) using the catalyst hypophosphoric acid (25 ppm) at 180° C. for 6 hours under atmospheric pressure while water was continuously removed by distillation. An intermediate (i.e. ester amine) may be cooled to room temperature, 110 g (0.2 moles) of the ester amine may be heated to 80° C. and 24.1 g (0.191 moles) of DMS may be added over the period of 105 minutes, and the reaction continued for an additional 10 minutes to allow DMS to react. Thereafter, 14.9 g of ethanol may be added continuously over the period of 80 minutes and the reaction continued for two hours at 80° C.

The fabric conditioners of the present invention comprise more than 1 wt. %, more preferably more than 2 wt. %, most preferably more than 3 wt. % ester linked quaternary ammonium compounds as described herein by weight of the composition. The fabric conditioners of the present invention comprise less than 20 wt. % ester linked quaternary ammonium compounds as described herein by weight of the fabric conditioner composition. Suitably the fabric conditioners comprise 1 to 20 wt. %, preferably 2 to 20 wt. % and more preferably 3 to 20 wt. % ester linked quaternary ammonium compounds as described herein by weight of the composition. The effect of the improved viscosity is particularly beneficially to so called ‘dilute’ compositions; these compositions preferably comprise 1 to 9 wt. %, more preferably 2 to 7 wt. % ester linked quaternary ammonium compounds as described herein.

The compositions described herein may include additional softening actives (in addition to the ester linked quaternary ammonium compounds described here). Additional materials known to soften fabrics may include; non-ester linked quaternary ammonium compounds, silicone polymers, polysaccharides, clays, amines, fatty esters, fatty acids, dispersible polyolefins, polymer latexes and mixtures thereof.

### Perfume

The compositions as described herein comprise 0.1 to 30 wt. % perfume materials i.e. free perfume and/or perfume microcapsules. As is known in the art, free perfumes and perfume microcapsules provide the consumer with perfume hits at different points during the laundry process. It is particularly preferred that the compositions of the present invention comprise a combination of both free perfume and perfume microcapsules.

Preferably the compositions of the present invention comprise 0.5 to 30 wt. % perfume materials, more preferably 1 to 20 wt. % perfume materials, most preferably 1 to 15 wt. % perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

The compositions of the present invention preferably comprise 0.5 to 20 wt. % free perfume, more preferably 0.5 to 12 wt. % free perfume.

Particularly preferred perfume components are blooming perfume components and substantive perfume components. Blooming perfume components are defined by a boiling point less than 250° C. and a LogP or greater than 2.5. Substantive perfume components are defined by a boiling point greater than 250° C. and a LogP greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The compositions of the present invention preferably comprise 0.5 to 20 wt. % perfume microcapsules, more preferably 0.5 to 12 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Preferably the encapsulated perfume compositions comprises at least 20 wt. % blooming perfume ingredients, more preferably at least 30 wt. % and most preferably at least 40 wt. % blooming perfume ingredients. Substantive perfume components are defined by a boiling point greater than 250° C. and a LogP greater than 2.5. Preferably the encapsulated perfume compositions comprise at least 10 wt. % substantive perfume ingredients, more preferably at least 20 wt. % and most preferably at least 30 wt. % substantive perfume ingredients. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

### Polymeric viscosity control agents

The compositions as described herein may preferably include a polymeric viscosity control agent. This may be particularly preferred in ‘dilute’ compositions. Polymeric viscosity control agents include nonionic and cationic polymers, such as hydrophobically modified cellulose ethers (e.g. Natrosol Plus, ex Hercules), cationically modified starches (e.g. Softgel BDA and Softgel BD, both ex Avebe), cationic cross linked polymers. Preferably the viscosity control agent is selected from cationic cross linked polymers. Cationic cross-linked polymers are derivable from the polymerization of from 5 to 100 mole percent of cationic vinyl addition monomer, from 0 to 95 mole percent of acrylamide and from 50 to 1000 ppm of a difunctional vinyl addition monomer cross-linking agent. Preferred cationic cross-linked polymers are cross-linked copolymers of acrylamide and methacrylate cross-linked with a difuncitonal vinyl addition monomer, such as methylene bisacrylamide. Particularly preferred cationic cross-linked polymers are copolymers of from about 20 percent acrylamide and about 80 percent MADAM methyl chloride (MADAM is dimethyl amino ethyl methacrylate) cross-linked with from 450 to 600 ppm of methylene bisacrylamide. Such materials are commercially available from SNF Floerger under the trade names Flosoft 200 and Flosoft 222 (ex SNF Floerger).

Polymeric viscosity control agents are preferably used in amounts of from 0.7 to 2.5 wt. %, preferably from 1 to 2 wt. % of the composition.

### Preservatives

The compositions as described herein preferably comprise preservatives, either a single preservative or a combination of preservatives. The level of preservatives is important to ensure preservation both before and after dilution of the concentrated formulations. Two preferred classes of preservatives are organic acid and/or the salts thereof and isothiazolinones. Examples of organic acid and/or the salts thereof are potassium sorbate and sodium benzoate. Examples of isothiazolinones are Methylisothiazolinone (MIT), Chloromethylisothiazolinone (CMIT) and Benzisothiazolinone (BIT). Generally preservatives are preferably included at an inclusion level of 0.005 to 1 wt. %, more preferably 0.01 to 0.8 wt. %. Preferred inclusion levels of organic acid and/or the salts thereof are 0.05 to 0.8 wt. % and preferred inclusion levels of isothiazolinones is 0.01 to 0.05 wt. %.

### Other ingredients

The concentrated compositions described herein may comprise other ingredients of fabric conditioner liquids as will be known to the person skilled in the art. Among such materials there may be mentioned: antifoams, insect repellents, shading or hueing dyes, anti-bacterial agents, anti-virus agents, pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

### Form of the invention

The compositions described herein are aqueous compositions. The compositions preferably comprise more than 50 wt. % water, more preferably more than 60 wt. % water.

### Method and use

The fabric conditioner compositions described herein are used in the laundry process. In particular ester linked quaternary ammonium compounds comprising carbon chains derived from fatty acids; the fatty acids having an iodine value of 0 to 75; and the fatty acids comprising non-edible rice bran fatty acids; maybe used as the fabric softening active in a method of reducing the viscosity of a fabric conditioner formulation. i.e. the fabric softening actives described herein, comprising carbon chains derived from fatty acids; the fatty acids having an iodine value of 0 to 75; and the fatty acids comprising non-edible rice bran fatty acids; may be added to a fabric conditioner composition as a replacement for an alternative fabric softening active and thereby reduce the viscosity. Preferably the fabric conditioners do not comprise fabric softening actives comprising carbon chains derived from sources other than rice bran oils.

In one aspect of the present invention, clothes are treated with the fabric conditioner composition. The treatment is preferably during the washing process. This may be hand washing or machine washing. Preferable the fabric conditioner is used in the rinse stage of the washing process.

Preferably the clothes are treated with a 10 to 100 ml dose of fabric conditioner for a 4 to 7 kg load of clothes. More preferably, 10 to 80 ml for a 4 to 7 kg load of clothes.

### EXAMPLES:

TABLE 1
Example composition

| | wt. % Composition | | |
|---|---|---|---|
| Ingredient | Concentrate | Regular | Dilute |
| Fabric Softening active¹ | 20 | 9 | 4 |
| Fatty alcohol | — | — | 0.5 |
| Nonionic surfactant | — | 1.5 | 0.01 |
| Cationic polymer² | 0.2 | 0.2 | 0.2 |
| Perfume | 2.0 | 0.8 | 0.3 |
| Microcapsule | 2.5 | 0.5 | — |
| Silicone Antifoam | 0.05 | 0.05 | 0.1 |
| Preservative | 0.7 | 0.7 | 0.7 |
| Mirrors, dyes, pH regulators, etc. | <1 wt. % | <1 wt. % | <1 wt. % |
| Water | To 100 | To 100 | To 100 |

Fabric Softening active¹—Prepared according to WO 2020/011876
Cationic polymer²—Flosoft 270LS ex. SNF

The example compositions may be produced using the following method: Pre-melt the fabric softening active at a temperature of ˜65° C. Separately heat the water to ˜45° C. and add antifoam, preservative and some minors. Slowly add the pre-melt with stirring. Add any remaining ingredients and slowly cool.

TABLE 2
Experimental compositions

| | wt. % active | | | | | |
|---|---|---|---|---|---|---|
| | A | 1 | B | 2 | C | 3 |
| Fabric softening active³ | — | 3 | — | 8 | — | 8 |
| (rice bran oil) | | | | | | |
| Fabric softening active⁴ | 3 | — | 8 | — | 8 | — |
| (palm oil) | | | | | | |
| C16/18 alcohol | 0.5 | 0.5 | — | — | — | — |
| Castor oil | — | — | 1 | 1 | — | — |
| Non-ionic surfactant: | — | — | — | — | 0.9 | 0.9 |
| C16/18 fatty | | | | | | |
| alcohol, +25 EO | | | | | | |
| Perfume microcapsule | — | — | 0.4 | 0.4 | 0.5 | 0.5 |
| Minors | <1 | <1 | <1 | <1 | <1 | <1 |
| Water | To 100 | To 100 | To 100 | To 100 | To 100 | To 100 |

Fabric softening active³—quaternary ammonium compound comprising fatty acid chains from non-edible rice bran oil having a composition of 20-30% C16 fatty acid chains and 65-75% C18 fatty chains.
Fabric softening active⁴—quaternary ammonium compound comprising fatty acid chains from palm oil having a composition of 40-50% C16 fatty acid chains and 40-60% C18 fatty chains.

The compositions were prepared by melting the fabric softening active and C16/18 alcohol, castor oil or non-ionic at a temperature of ˜65° C. to form a pre-melt. Separately the minors were dispersed in water at ˜45° C. The pre-melt was then added to the water with stirring. Finally, the perfume microcapsules were added and the mixture cooled to room temperature.

Viscosity measurements of the fresh product were taken. The viscosity was measured using a Haake™ MARS™ Rheometer ex. Thermo Scientific, using a cone and plate geometry set to a 1° cone angle.

Measurements were taken at a temperature of 25° C. and shear rate of 2s-1, 20s-1 and 106s-1. Sixty data points were taken for each shear rate at a rate of approximately one per second. The average of the last 30 data points were taken as the viscosity measure.

Measurements taken at 2s⁻¹, 20s⁻¹ and 106s⁻¹. 60 data points taken for each rate of approximately one per second. The average of the last 30 data points were taken as the viscosity measure.

TABLE 3
Viscosity results

| | 2 s⁻¹ | 20 s⁻¹ | 106 s⁻¹ |
|---|---|---|---|
| A | 583.9 | 118.2 | 43.96 |
| 1 | 257.3 | 65.69 | 28.95 |
| B | 237.7 | 62.38 | 32.21 |
| 2 | 154.6 | 55.68 | 30.93 |
| C | 535.7 | 117.6 | 49.75 |
| 3 | 264.2 | 72.54 | 33.63 |

These results demonstrate that substituting a palm oil derived fabric softening active with an ester linked quaternary ammonium as described herein, leads to a reduction in the viscosity of the product.

8. An aqueous fabric conditioner composition comprising;
a. 1 to 9 wt. % ester linked quaternary ammonium compounds; and
b. 0.1 to 30 wt. % perfume materials;
wherein the ester linked quaternary ammonium compounds comprise carbon chains derived from fatty acids;
the fatty acids have an iodine value of 0 to 75; and
the fatty acids comprise non-edible rice bran fatty acids
wherein the ester linked quaternary ammonium compound comprises 20 to 35% C₁₆ fatty acid chains and 60 to 75% C₁₈ fatty acid chains by weight of total fatty acid chains.

9. The composition according to claim 8, wherein the fatty acids comprise at least 50% non-edible rice bran fatty acids.

10. The composition according to claim 8, wherein the fabric conditioner composition further comprises a softening active which is a non-ester linked quaternary ammonium compound, silicone polymer, polysaccharide; clay, fatty ester, fatty acid, dispersible polyolefins, polymer latex or an amine or a mixture thereof.

11. The composition according to claim 8, wherein the fabric conditioner composition comprises 0.5 to 20 wt. % free perfume.

12. The composition according to claim 8, wherein the fabric conditioner composition comprises 0.5 to 20 wt. % perfume microcapsules.

13. The composition according to claim 8, wherein the fabric conditioner composition comprises a preservative.

14. The composition according to claim 8, wherein the fabric conditioner composition further comprises at least one of antifoams, insect repellents, shading or hueing dyes, anti-bacterial agents, anti-virus agents, pH buffering agents, perfume carriers, hydrotropes, anti-redeposition agents, soil-release agents, polyelectrolytes, anti-shrinking agents, anti-wrinkle agents, anti-oxidants, sunscreens, anti-corrosion agents, drape imparting agents, anti-static agents, sequestrants or ironing aids.

15. The composition according to claim 8, wherein the fabric conditioner composition further comprises at least one of pearlisers, opacifiers or sequestrants.

16. A method of reducing the viscosity of a fabric conditioner composition comprising the step of including ester linked quaternary ammonium compounds comprising carbon chains derived from fatty acids in the fabric conditioner composition wherein the fatty acids have an iodine value of 0 to 75 and non-edible rice bran fatty acids and further wherein the compounds are included in the fabric conditioner composition as fabric softening active.
